(19) United States
(12) Patent Application Publication
(10) Pub. No.: US 2022/0145829 A1
(43) Pub. Date: May 12, 2022

(54) POSITIVE RETENTION EXPANSION JOINTS

(71) Applicant: General Electric Company, Schenectady, NY (US)

(72) Inventors: Naleen Kumar Verma, Bengaluru (IN); Daniel D. Smith, Mason, OH (US); Urmi Tejaswini, Bengaluru (IN); Mario Alberto Bolaños Jimenez, Queretaro (MX); Dattu G.V. Jonnalagadda, Bengaluru (IN)

(21) Appl. No.: 17/523,441

(22) Filed: Nov. 10, 2021

(30) Foreign Application Priority Data
Nov. 11, 2020 (IN) 202011049252

(51) Int. Cl. F02K 1/80; F16L 21/035; F16L 33/28; F16L 41/08

(52) U.S. Cl. CPC F02K 1/80; F16L 21/035; F05D 2230/64; F16L 41/08; F16L 33/28

(57) ABSTRACT

An expansion joint for a jet engine, the expansion joint including a pipe defining a proximal end having a first engagement structure, wherein the pipe is part of an air system of the jet engine; and an engine hardware coupled with the proximal end of the pipe, the engine hardware having a second engagement structure engaged with the first engagement structure to couple the pipe and engine hardware relative to one another, wherein one of the first and second engagement structures comprises one or more spring fingers, and wherein the other of the first and second engagement structures comprises a ridge extending along a circumferential direction of such engagement structure.

### CROSS-REFERENCE TO RELATED APPLICATIONS

The present application claims priority to Indian Patent Application No. 202011049252, filed Nov. 11, 2020, which is hereby incorporated by reference in its entirety.

### FIELD

The present subject matter relates to positive retention expansion joints on jet engines.

### BACKGROUND

Jet engines operate by combusting gas and air together to generate exhaust which is directed through a nozzle to generate thrust. To accommodate combustion, jet engines include air systems that transport air along prescribed pathways through the engine. The air pathways are generally defined by pipes which travel across the engine and interconnect with one another and other portions of the engine at one or more joints. It is sometimes desirable for these joints to operate like expansion joints, permitting relative motion between moving parts so as to relax interface load transfer caused by thermal, pressure, and dynamic loading conditions.

The jet engine industry continues to demand improvements to jet engine performance and operational longevity such as improved loading conditions on components to increase operational lifespan.

### BRIEF DESCRIPTION

Aspects and advantages of the invention will be set forth in part in the following description, or may be obvious from the description, or may be learned through practice of the invention.

In one exemplary aspect of the present disclosure, an expansion joint for a jet engine comprises a pipe defining a proximal end having a first engagement structure, wherein the pipe is part of an air system of the jet engine. The expansion joint further comprises an engine hardware coupled with the proximal end of the pipe, the engine hardware having a second engagement structure engaged with the first engagement structure to couple the pipe and engine hardware relative to one another.

In another exemplary aspect of the present disclosure, a pipe for an air system of a jet engine comprises a conduit and a collar disposed at a proximal end of the conduit and configured to be coupled to the engine hardware. The collar comprises a first engagement structure including a plurality of spring fingers configured to be coupled with the second engagement structure of the engine hardware. The collar further comprises indicia marking an axial alignment location of the pipe relative to the engine hardware in an axial direction.

In another exemplary aspect of the present disclosure, a method of forming a jet engine expansion joint comprises moving a proximal end of a pipe having a first engagement structure towards an engine hardware defining a bore and having a second engagement structure, aligning the pipe and engine hardware such that the pipe and the bore of the engine hardware are coaxial with one another, and translating the pipe and engine hardware together until the first engagement structure and the second engagement structure engage with one another.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a perspective view of a portion of a jet engine in accordance with an embodiment of the present disclosure.

FIG. 2 is a perspective view of a portion of an expansion joint for use on a jet engine in accordance with an embodiment of the present disclosure.

FIG. 3 is a cross sectional side view of an expansion joint for use on a jet engine in accordance with an embodiment of the present disclosure.

FIG. 4 is a perspective view of a portion of an expansion joint for use on a jet engine in accordance with an embodiment of the present disclosure.

FIG. 5 is a cross sectional side view of an expansion joint for use on a jet engine in accordance with an embodiment of the present disclosure.

FIG. 6 is a perspective view of a portion of an expansion joint for use on a jet engine in accordance with an embodiment of the present disclosure.

FIG. 7 is a perspective view of a portion of an expansion joint for use on a jet engine in accordance with an embodiment of the present disclosure.

FIG. 8 is a cross-sectional side view of an expansion joint for use on a jet engine in accordance with an embodiment of the present disclosure.

FIG. 9 is a perspective view of an expansion joint for use on a jet engine where the expansion joint is partially assembled in accordance with an embodiment of the present disclosure.

FIG. 10 is a perspective view of an expansion joint for use on a jet engine where the expansion joint is in a locked state in accordance with an embodiment of the present disclosure.

FIG. 11 is a collar for a pipe of an expansion joint in accordance with an embodiment of the present disclosure.

FIG. 12 is a method of installing an expansion joint on a jet engine in accordance with an embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, affixing, or attaching, as well as indirect coupling, affixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In accordance with one or more aspects of the present disclosure, a jet engine expansion joint generally includes a pipe coupled with engine hardware (such as, e.g., a bore extending into the engine, or a component thereof, from an outer surface). The pipe includes a first engagement structure and the engine hardware includes a second engagement structure configured to be coupled to the first engagement structure. The first and second engagement structures can be releasably coupled together. By way of example, the first engagement structure can include one or more spring fingers and the second engagement structure can include a circumferentially extending ridge that, when interfaced with the spring fingers, couple the pipe and engine hardware together. When coupled together, the pipe can be used as part of an air system of the jet engine, configured to transport air to and/or from the jet engine or a component(s), or sub component(s) thereof, through the engine hardware without damage resulting from overloading conditions.

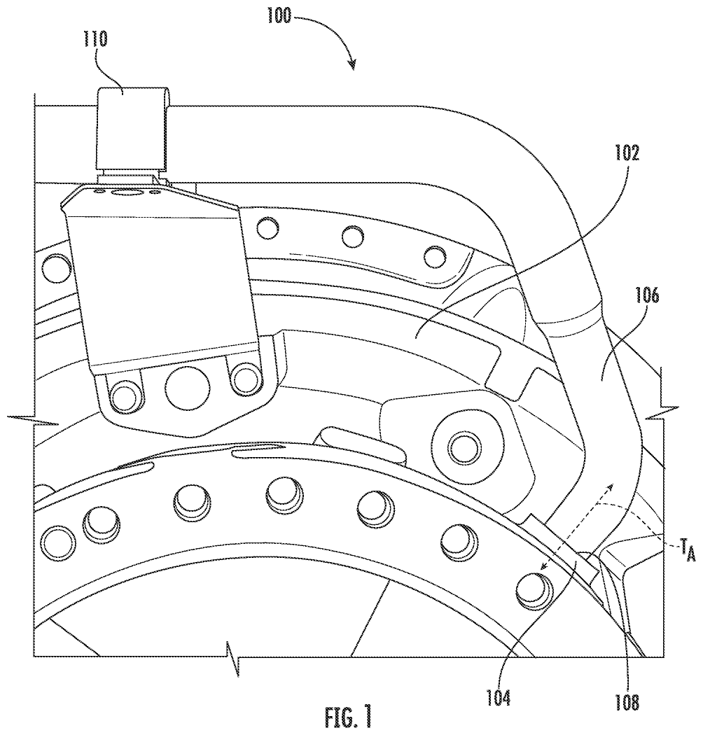

FIG. 1 illustrates a view of a portion of a jet engine 100 including a jet engine body 102 with an engine hardware 104. In an embodiment, the engine hardware 104 can include an interface for receiving and/or discharging air from the engine 100, such as to or from a combustion area of the jet engine 100. The engine hardware 104 can define a bore extending into the engine body 102 through which the air can pass. A pipe 106 can be fluidly coupled with the engine hardware 104 to allow transport of air relative to the engine 100. For instance, the pipe 106 can be part of an air intake system, an exhaust system, another air transport system, or the like. In such a manner, it will be appreciated that the term “pipe” may refer broadly to any fluid transport structure, such as a conduit, hose, tube, etc. The pipe may be substantially rigid, semi-rigid, or flexible.

The pipe 106 may be secured to the engine body 102 through one or more intermediate interfaces, such as through exemplary interface 110. In certain instances, the pipe 106 may not be coupled to the engine body 102 at any location other than at the axial ends thereof, e.g., where the pipe 106 engages with the engage hardware 104. For instance, the engine 100 can be devoid of the exemplary interface 110.

During typical engine operation, the interface between the pipe 106 and engine hardware 104 can be subjected to loading conditions caused, for example, by changing thermodynamic temperature profiles, deformation or movement of one or more of the components, or the like. Over prolonged use, such loading conditions can weaken structure of the jet engine 100, causing engine damage, reduced operational longevity, and/or reduced aerodynamic efficiency.

To compensate for such loading conditions, it may be possible to utilize an expansion joint 108 at the interface formed between the pipe 106 and the engine hardware 104. The expansion joint 108 can permit axial, rotational, and/or pivotal movement between the pipe 106 and engine hardware 104 such that loading conditions are minimized and component longevity is increased. In one or more embodiments described herein, the use of the expansion joint 108 on the engine body 102 can reduce part count as separate attachment protocol to secure the pipe 106 to the engine hardware 104 may not be required.

Use of expansion joints 108 with integral locking features as described in accordance with one or more embodiments herein may facilitate easier installation and/or removal of the pipe 106 from the engine hardware 104 and/or enhance desirable attributes of the expansion joint 108 so to accommodate the loading conditions experienced during typical operation. Integral locking features on the pipe 106 can be used with complementary features on the engine hardware 104 to secure the pipe 106 and engine hardware 104 together relative to one another.

FIG. 2 illustrates an exemplary view of a proximal end 200 of the pipe 106 shown in FIG. 1 as depicted removed, i.e., uninstalled, from the engine hardware 104. In the illustrated embodiment, the pipe 106 includes a conduit 202 and a collar 204 disposed at, e.g., forming, the proximal end 200 of the pipe 106. The conduit 202 can include, for example, tubing, piping, one or more fluid channels and/or passages, or the like. By way of example, the conduit 202 can include a pipe segment extending between a combustion area of the engine 100 and an air system (not illustrated) for transporting fluid, e.g., air, to and/or from the combustion area of the engine 100. The collar 204 can be secured to the conduit 202 through any suitable attachment protocol, such as through the use of one or more of adhesives, mating threads, a bayonet connection, pins, threaded or non-threaded fasteners, interference fit, or the like. The collar 204 can be in fluid communication with the conduit 202. In a non-illustrated embodiment, the conduit 202 and collar 204 can be integral with one another, e.g., monolithic. Thus, one of ordinary skill in the art will understand that reference made herein to portions or features of the collar 204 can alternatively refer to portions of the conduit 202 at, or near, the proximal end 200 of the pipe 106.

In an embodiment, the collar 204 can include a strong material configured to operate at high temperatures (e.g., in excess of 500 degrees Fahrenheit, such as in excess of 750 degrees Fahrenheit, such as in excess of 1000 degrees Fahrenheit). Exemplary materials include steel, Inconel, and titanium, as well as other alloys and suitable metals that meet high temperature applications. Electroformed conduits (described in greater detail below) may consist, for example, of nickel and high strength alloys thereof.

The pipe 106 can include one or more features configured to fluidly couple the pipe 106 relative to the engine hardware 104. For instance, the collar 204 can include a first engagement structure 206 configured to engage with one or more features (e.g., the second engagement structure 300 described hereinafter) of the engine hardware 104 to fluidly couple the pipe 106 and engine hardware 104 together. In the illustrated embodiment, the first engagement structure 206 includes one or more spring fingers 208 extending from a hub 210 of the collar 204 in a generally axial direction A of the pipe 106. The spring fingers 208 may also extend at least slightly radially, in that a best fit line BL of the spring finger 208 intersects a central axis of the pipe 106 in the axial direction A. In an embodiment the one or more spring fingers 208 can include at least two spring fingers, such as at least three spring fingers, such as at least four spring fingers, such as at least five spring fingers. The spring fingers 208 can define the proximal end 200 of the pipe 106. As shown, the spring fingers 208 can extend from an axial end of the hub 210. In another embodiment, at least one of the spring fingers 208 may extend from a side surface, e.g., a radially internal side or radially external side, of the hub 210. In an embodiment, the spring fingers 208 may share a common length, as measured in the axial direction A. In another embodiment, at least two of the spring fingers 208 may have different lengths as compared to one another.

The spring fingers 208 can include one or more coatings, such as one or more wear coatings, environmental coatings, and the like. In a particular embodiment, an exemplary wear coating includes a film lubricant such as polytetrafluoroethylene (PTFE). The wear coating can include graphite, molybdenum disulfide, or a combination thereof.

In an embodiment, at least one of the spring fingers 208 can include a tined portion 212 extending from the hub 210 of the collar 204. The tined portion 212 can include engagement features, such as one or more radially-extending lip(s) 214, configured to engage with complementary features of the engine hardware 104 (e.g., the second engagement structure 300 described hereinafter). In certain instances, the lip 214 of each tined portion 212 can have the same, or similar, cross-sectional profiles as compared to one another. In other instances, at least two of lips 214 can have different cross-sectional profiles as compared to one another. In an embodiment, the lips 214 on all of the spring fingers 208 can extend radially outward, radially inward, or both.

In certain instances, the tined portions 212 can be equally, or approximately equally, spaced apart from one another in a circumferential direction of the pipe 106. In other instances, a distance between a first pair of adjacent tined portions 212 can be different than a distance between a second pair of adjacent tined portions 212 different than the first pair of adjacent tined portions 212.

In the illustrated embodiment, a gap 216 disposed between adjacent tined portions 212 can be defined by a generally arcuate curvature in the sidewall of the collar 204. In a non-illustrated embodiment, the gap 216 can be defined by one or more linear segments, a plurality of segments, or have another suitable shape so as to permit installation of the pipe 106 relative to the engine hardware 104. The gaps 216 can have similar or dissimilar shapes as compared to one another.

The tined portions 212 can be configured to deflect, such as in a radial direction, during engagement of the pipe 106 with the engine hardware 104. For instance, as the pipe 106 is translated relatively towards the engine hardware 104, the tined portions 212 can pass by complementary feature(s) of the engine hardware 104 which causes the tined portions 212 to deflect in the radially-inward direction. After passing over the complementary feature(s) of the engine hardware 104, the tined portions 212 can deflect back to a non-biased, or less-biased state, to secure the pipe 106 relative to the engine hardware 104. In this state, the expansion joint 108 may be considered locked, i.e., the expansion joint 108 is ready to operate under loading conditions caused by typical engine use.

In an embodiment, the force required to deflect the tined portions 212 can be configured to permit easy installation of the pipe 106 relative to the engine hardware 104 while simultaneously preventing undesirable, e.g., accidental, decoupling therebetween. By way of example, the tined portions 212 can be configured to deflect upon application of a radial loading force in a range between 0.01 pounds per square inch (PSI) and 100 PSI per tined portion 212, as measured by a vector of the force as measured in a direction normal to the axial direction A. In a more particular embodiment, each tined portion 212 can be configured to deflect upon application of a radial loading force in a range between 0.5 PSI and 75 PSI, such as in a range between 0.75 PSI and 50 PSI, such as in range between 1 PSI and 40 PSI, such as in a range of 2 PSI and 15 PSI.

In an embodiment, the tined portions 212 can have a spring rate in a range of 0.1 lbs/in and 200 lbs/in, such as in a range of 0.5 lbs/in and 100 lbs/in, such as in a range of 1 lbs/in and 75 lbs/in, such as in a range of 5 lbs/in and 50 lbs/in.

In certain instances, the force required to install the pipe 106 on the engine hardware 104 can be less than the force required to remove the pipe 106 from the engine hardware 104. For example, the installation force, F_{I}, may be less than 99% a removal force, F_{R}, such as less than 95% F_{R}, such as less than 90% F_{R}, such as less than 80% F_{R}, such as less than 60% F_{R}. One exemplary method of accomplishing a differential force profile, i.e., different install and removal forces, may include selective geometric profile design of the spring fingers 208 or another component of the expansion joint 108 which more readily creates deflection in one direction of translation as compared to the opposite direction.

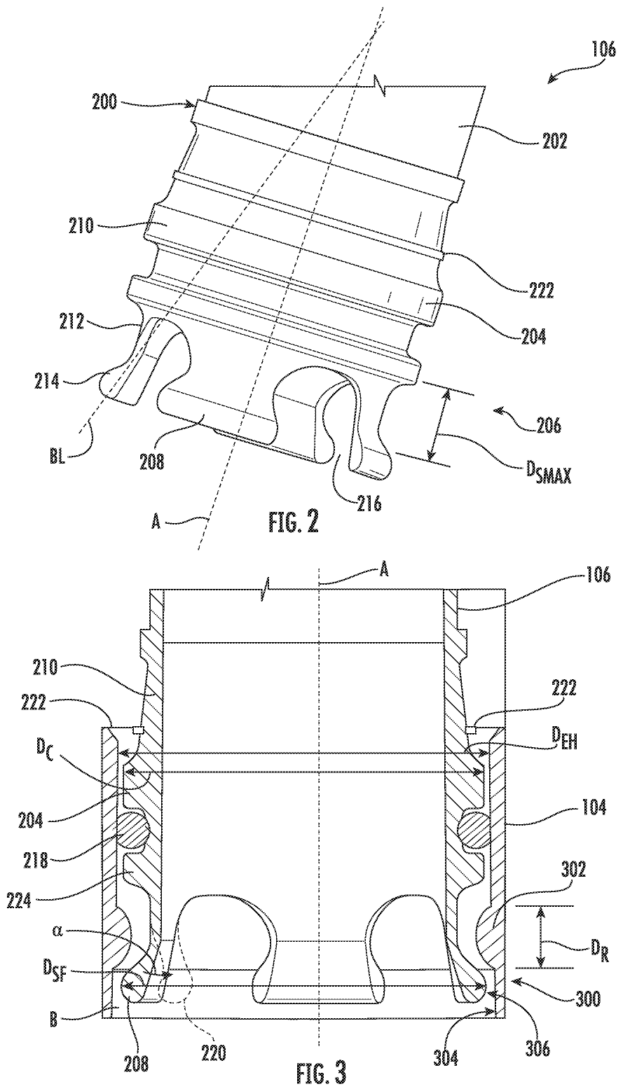

The dashed lines 220 illustrated in FIG. 3 represents a deflected position of the spring finger 208 as encountered, e.g., as the spring finger 208 passes the secondary engagement feature 300, such as a circumferentially-extending ridge 302 of the engine hardware 104. As depicted, the deflected position of the spring finger 208 is angularly offset from the unbiased, i.e., non-deflected, spring finger 208 by an angle, α. In an embodiment, the angle, α, is at least 1°, such as at least 2°, such as at least 3°, such as at least 4°, such as at least 5°, such as at least 10°, such as at least 15°, such as at least 20°. In certain instances, all of the spring fingers 208 can be configured to deflect by an approximately same angle, α. In other instances, the spring fingers 208 can deflect by varying degrees, e.g., as a result of the angle of force applied to the pipe 106 during installation or removal relative to the engine hardware 104. Flexure in the embodiment illustrated in FIG. 3 may be primarily, or fully, caused by radial loading force from the circumferentially-extending ridge 302 created as the spring finger 208 is translated thereby in the axial direction A.

The tined portion 212 can include a material configured to elastically deform upon deflecting during engagement with the engine hardware 104. It should be appreciated that in certain instances plastic deformation can simultaneously occur, particularly during the initial flexure(s) of the tined portion 212 associated with the first installation. In one or more embodiments, the tined portions 212 can be formed from a same material as the collar 204. In another embodiment, the tined portions 212 can be formed from a secondary material different from the material of the hub 210. For example, the tined portions 212 can be formed from a different material attached to the hub 210, overmolded to the hub 210, or the like.

Referring to FIG. 3, the collar 204 can further include a sealing feature, such as an O-ring 218 extending around a circumferential dimension of the collar 204. As illustrated, the O-ring 218 can be disposed between the tined portion 212 and the conduit 202. The O-ring 218 can be seated within a channel extending around at least a portion of a circumference of the collar 204. When installed in the engine hardware 104, the O-ring 218 can seal an annulus formed between the pipe 106 and engine hardware 104 so as to prevent fluid, e.g., air, leakage.

The collar 204 can define a maximum slip distance, D_{SMAX}, as defined by a distance within which a complementary feature of the engine hardware 104 (e.g., the circumferentially-extending ridge 302) can slide to permit expansion of the expansion joint 108. The maximum distance of sliding may be less than the maximum slip distance, D_{SMAX}, as determined by relative dimensions of the collar 204 and engine hardware 104, such as an axial dimension, D_{R}, of a circumferentially-extending ridge of the engine hardware 104, as measured in the axial direction A. The dimension, D_{R}, of the circumferentially-extending ridge 302 can be less than the maximum slip distance, D_{SMAX}. For example, in an embodiment, D_{R} can be less than 0.99 D_{SMAX}, such as less than 0.98 D_{SMAX}, such as less than 0.95 D_{SMAX}, such as less than 0.9 D_{SMAX}, such as less than 0.75 D_{SMAX}, such as less than 0.5 D_{SMAX}. In another embodiment, D_{R} can be at least 0.001 D_{SMAX}, such as at least 0.1 D_{SMAX}, such as at least 0.25 D_{SMAX}. In certain instances, the difference between D_{SMAX} and D_{R} [D_{MAXSLIDE}=D_{SMAX}−D_{R}] can be equal to, or approximately equal to, the maximum relative sliding distance, D_{MAXSLIDE}, between the pipe 106 and the engine hardware 104. In an embodiment, D_{MAXSLIDE} can refer to the maximum sliding distance between the pipe 106 and engine hardware 104 without deflection of the spring fingers 208 and/or circumferentially-extending ridge 302. That is, D_{MAXSLIDE} may be calculated between maximum opposite axial positions with the spring fingers 208 in the unbiased state. In another embodiment, D_{MAXSLIDE} can be calculated by a maximum sliding distance between the pipe 106 and engine hardware 104 with at least some deflection occurring at the spring fingers 208 and/or circumferentially-extending ridge 302. That is, D_{MAXSLIDE} may define total axial displacement of the expansion joint 108 with more than a nominal amount of deflection occurring at one or more components thereof, such as the spring fingers 208, below a threshold deflection value at which point the expansion joint 108 can be decoupled, i.e., the pipe 106 can be removed from the engine hardware 104 with application of minimal force. D_{MAXSLIDE} can correlate with the tolerances required at the expansion joint 108. For instance, for high tolerance interfaces, D_{MAXSLIDE} can be increased, e.g., by elongating the spring fingers 208, moving upstream structure, e.g., structure 224, further away from the spring finger 208, or the like. Conversely, in low tolerance interfaces, D_{MAXSLIDE} can be decreased, e.g., by reducing the axial length of the spring fingers 208, moving upstream structure 224 closer to the spring finger 208, or the like. In exemplary embodiments, D_{MAXSLIDE} can be in a range between 0.5 inches and 24 inches, such as in a range between 0.75 inches and 12 inches, such as in a range between 1 inch and 6 inches.

As illustrated in FIG. 3, the spring fingers 208 of the collar 204 can have outer surface cross-sectional profiles similar to, or the same as, the inner surface 304 of the circumferentially-extending ridge 302. In such a manner, the circumferentially-extending ridge 302 and spring fingers 208 can interface with one another in a close-fit arrangement when disposed at maximum axial (engaged) positions. That is, the circumferentially-extending ridge 302 and spring fingers 208 can have a large amount of surface contact area at the edges of axial translation. In other embodiments, the inner surface 304 of the circumferentially-extending ridge 302 and outer surfaces(s) 306 of the spring fingers 208 can have different cross-sectional surface profiles as compared to one another.

In an embodiment, the outer surface 306 of the hub 210 of the collar 204 can define a diameter, D_{C}, as measured, for example, at the upstream structure 224, that is less than a diameter, D_{EH}, of the engine hardware 104. For example, D_{C} can be less than 0.99 D_{EH}, such as less than 0.98 D_{EH}, such as less than 0.97 D_{EH}, such as less than 0.96 D_{EH}, such as less than 0.95 D_{EH}, such as less than 0.9 D_{EH}. In such a manner, the collar 204 can readily slide relative to the bore B of the engine hardware 104. In certain instances, a diameter, D_{SF}, of the outer surface 306 of the spring finger(s) 208 can be no less than the diameter, D_{C}, of the hub 210. For instance, D_{SF} can be at least 1.0 D_{C}, such as at least 1.01 D_{C}, such as at least 1.02 D_{C}, such as at least 1.03 D_{C}, such as at least 1.04 D_{C}, such as at least 1.05 D_{C}, such as at least 1.1 D_{C}. In a particular embodiment, D_{SF} can define a value between D_{C} and D_{EH}.

The expansion joint 108 can be configured to be assembled by aligning the pipe 106 relative to the bore B of the engine hardware 104 and sliding at least one of the pipe 106 and engine hardware 104 together relative to each other. As illustrated in FIG. 3, the pipe 106 can be inserted into the engine hardware 104 until the spring fingers 208 pass the circumferentially-extending ridge 302. The installing operator may feel a tactile indication, e.g., a click, as the spring fingers 208 pass the circumferentially-extending ridge 302. An audible sound may also, or alternatively, be generated. The O-ring 218 may create resistance to relative movement between the engine hardware 104 and the pipe 106 so as to prevent the expansion joint 108 from moving undesirably upon occurrence of low-frequency vibrations. The O-ring 218 may also form an interface between the pipe 106 and engine hardware 104 so as to keep the pipe 106 centered. After installation, the operator may test the expansion joint 108 by sliding the pipe 106 and/or engine hardware 104 to determine if proper D_{MAXSLIDE} is achieved.

In an embodiment, the expansion joint 108 can include indicia 222 configured to indicate to the operator when proper alignment between the pipe 106 and the engine hardware 104 is achieved. The indicia 222 can include a feature that permits the operator to determine when the pipe 106 is properly installed relative to the engine hardware 104. That is, the indicia 222 can signal to the operator that correct axial alignment is achieved. By way of example, the indicia 222 can include a ring, a notch, a groove, a structure extending discontinuously around the collar 204, textual or symbolic information, measurement datum, projecting tines, or the like. The indicia 22 can be disposed on the collar 204 or the engine hardware 104. As depicted in FIG. 3, the indicia 222 is disposed on the pipe 106 and is configured to be aligned with an open end 224 of the engine hardware 104 to indicate to the operator that the pipe 106 is at a proper location with respect to the engine hardware 104. For instance, the indicia 222 can align with the open end 224 of the engine hardware 104 when the spring finger(s) 208 are past the circumferentially-extending ridge 302. In a more particular embodiment, the indicia 222 can align with the open end 224 when the circumferentially-extending ridge 302 is disposed approximately halfway along the maximum slip distance, D_{SMAX}, such that the circumferentially-extending ridge 302 has approximately equal slip distance, e.g., tolerance, on either axial side thereof. Instructional materials may appear on the outer surface of the hub 210 to instruct an operator of proper alignment protocol. For instance, the instructional materials may indicate whether proper alignment is on an upstream or downstream side of the indicia 222 or describe the correct alignment location relative to the engine hardware 104.

The expansion joint 108 can be configured to withstand a decoupling force, i.e., a force which causes the pipe 106 and engine hardware 104 to separate from each other, of at least 1 Newton (N), such as at least 2 N, such as at least 3 N, such as at least 4 N, such as at least 5 N, such as at least 10 N, such as at least 25 N, such as at least 50 N, such as at least 75 N, such as at least 100 N. Considerations affecting decoupling force include, for example, geometry design of the spring fingers 208, material selection, radial height of the circumferentially-extending ridge 302 (i.e., in the direction normal to the axial direction A), the cross-sectional profile of at least one of the spring fingers 208 and circumferentially-extending ridge 302, and the like. Stiffer expansion joints 108 may be more suitable in certain applications, e.g., where forces and misalignment are more common, while more supple expansion joints 108 may be suitable for other applications, e.g., where loading forces are minimal and/or where overload protection is more critical.

Referring again to FIG. 1, use of the expansion joint 108 can permit the pipe 106 to translate relative to the engine hardware 104 along a translational axis, T_{A}. The limits of T_{A} can be set by design of the collar 204, the engine hardware 104, the like, or any combination or sub-combination thereof.

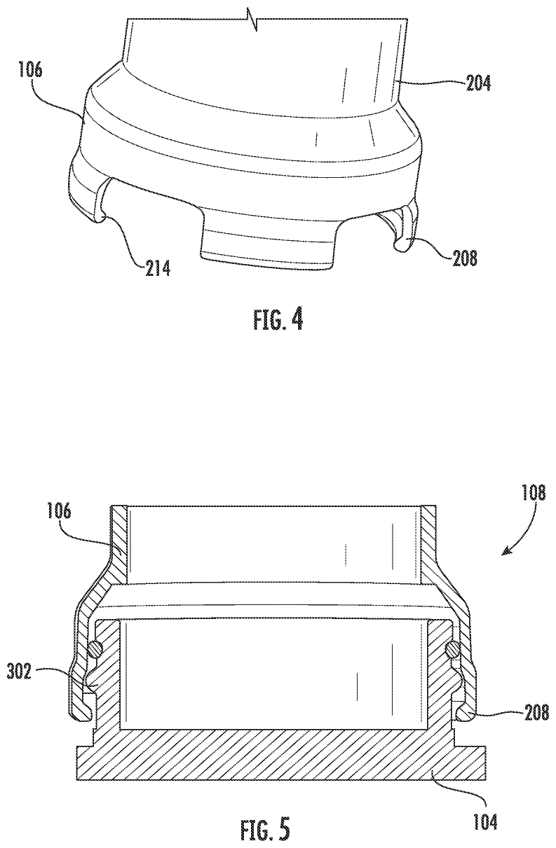

Referring now to FIGS. 4 and 5, in accordance with another embodiment, the expansion joint 108 can include the pipe 106 and engine hardware 104 as previously described with respect to FIGS. 2 and 3, however, the expansion joint 108 can have an opposite circumferential arrangement. That is, the pipe 108 can extend circumferentially around the engine hardware 104 in the installed state. Operation of the expansion joint 108 can be substantially similar to that previously described with respect to FIGS. 2 and 3. For instance, the pipe 106 and engine hardware 104 can be coupled together by translating the pipe 106 and the engine hardware 104 together until spring fingers 208 of the pipe 106 pass a circumferentially-extending ridge 302 of the engine hardware 104. Similarly, the pipe 106 and engine hardware 104 can be uncoupled by translating the pipe 106 and engine hardware 104 away from one another. Additionally, D_{MAXSLIDE} may be defined by D_{SMAX}−D_{R} as previously described with respect to FIGS. 2 and 3. However, unlike the embodiment illustrated in FIGS. 2 and 3, where D_{SMAX} is defined by the inner pipe 106 and D_{R} is defined by the outer engine hardware 104, in the embodiment illustrated in FIGS. 4 and 5, D_{SMAX} can be defined by the outer pipe 106 and D_{R} can be defined by inner engine hardware 104.

As illustrated in FIG. 4, the spring fingers 208 may include a plurality of spring fingers 208 equally spaced apart from one another in the circumferential direction. As shown, each of the spring fingers 208 can include one or more lips 214 configured to engage with the circumferentially-extending ridge 302 of the engine hardware 104. Unlike the embodiment previously described, the lips 214 can extend radially inward toward the circumferentially-extending ridge 302. Upon contact therewith, the spring fingers 208 may deflect in a radially outward direction, i.e., away from a central axis of the collar 204 and seat on the opposing side of the circumferentially-extending ridge 302.

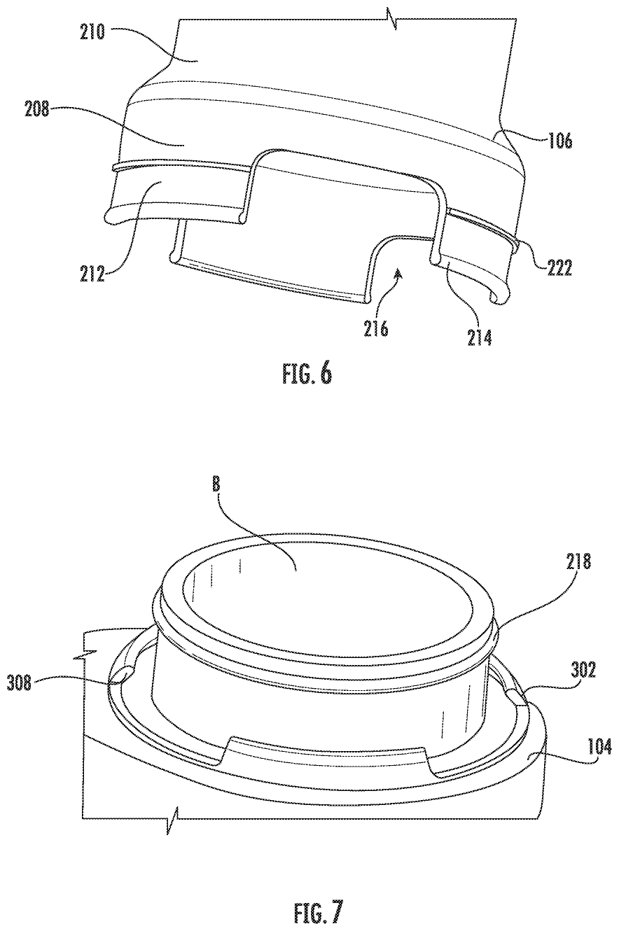

FIGS. 6 to 10 illustrate an expansion joint 108 in accordance with yet another embodiment. Similar to the expansion joint 108 depicted in FIGS. 2 and 3, in the expansion joint 108 illustrated in FIGS. 6 to 10 the pipe 106 includes outwardly extending radial lips 214 that engage with inwardly-extending circumferentially-extending ridge 302 of the engine hardware 104. However, unlike the embodiment depicted in FIGS. 2 and 3, the pipe 106 of the embodiment illustrated in FIGS. 6 to 10 is disposed circumferentially outside of the engine hardware 104. The circumferentially-extending ridge 302 can be spaced apart from the bore B of the engine hardware 104 and instead extend from a nearby (e.g., adjacent) surface. The circumferentially-extending ridge 302 can include a complementary lip 308 configured to be engaged with the lip 214 of the pipe 106. In the illustrated embodiment, the complementary lip 308 of the engine hardware 104 has a similar shape as the lip 214 of the pipe 106. In other embodiments, the complementary lip 308 and lip 214 can have dissimilar shapes.

In an embodiment, the circumferentially-extending ridge 302 can be multi-segmented, including a plurality of circumferentially spaced-apart portions. For instance, the circumferentially-extending ridge 302 can include at least two discrete lips 308, such as at least three discrete lips 308, such as at least four discrete lips 308, such as at least five discrete lips 308. The discrete lips 308 can each be coupled to, or integral with, a spring finger-like component of the engine hardware 104. In certain instances, the discrete lips 308 can be equally, or substantially equally, spaced apart from one another. It should be appreciated that the pipe 106 and engine hardware 104 depicted in FIGS. 6 and 7 could be modified to have different spatial arrangements without deviating from the disclosure herein. For example, the lips 308 can extend radially outward and the lips 214 of the pipe 106 can extend radially inward in the embodiment illustrated in FIGS. 6 and 7 while the pipe 106 remains disposed radially outside the engine hardware 104.

The spring fingers 208 of the pipe 106 illustrated in FIGS. 6 to 10 can be configured to engage with the lips 308 of the engine hardware 104 in a manner as previously described with respect to FIGS. 2 to 5. However, unlike the embodiments illustrated in FIGS. 2 to 5, the embodiment depicted in FIGS. 6 to 10 can require a rotational operation in order to positively couple the pipe 106 to the engine hardware 104. That is, unlike the embodiments of FIGS. 2 to 5 in which the pipe 106 and engine hardware 104 can be positively coupled together through only axial translation, the embodiment of FIGS. 6 to 10 can require a rotational operation to positively couple the pipe 106 and engine hardware 104 together. By way of example, the pipe 106 and engine hardware 104 can be translated together with each spring finger 208 of the pipe 106 at least substantially aligned with a gap 310 disposed between adjacent lips 308. After the lips 214 pass between the lips 308 of the engine hardware 104, at least one of the pipe 106 and engine hardware 104 can be rotated relative to the other to positively couple the expansion joint 108. Rotation may occur in a plane substantially normal with the axial direction A of the expansion joint 108. By way of example, relative rotation between the pipe 106 and engine hardware 104 may include at least 1° of rotation, such as at least 2° of rotation, such as at least 3° of rotation, such as at least 4° of rotation, such as at least 5° of rotation, such as at least 10° of rotation, such as at least 30° of rotation. In certain instances, rotation may occur in either rotational direction, e.g., clockwise and/or counterclockwise. In other instances, coupling may occur through a first rotational direction and uncoupling may occur through a second rotational direction different than the first rotational direction. In an embodiment, the lips 214, lips 308, or both can define one or more stop features (not illustrated) which engage or interface with a complementary feature on the other of the lips 214 and lips 308 so as to prevent, or reduce the probability of, further rotation therebetween. For instance, a bayonet type connection between the lips 214 and lips 308 may prevent the expansion joint 108 from decoupling upon occurrence of significant rotational loading. Alternatively, a notch disposed, e.g., at a circumferential end of the lip 308, may engage a circumferential side of the lip 214 so as to prevent the pipe 106 from rotating past a threshold location.

In the non-limiting depicted embodiment, the pipe 106 includes three spring fingers 106 equally spaced apart from one another in the circumferential direction. The engine hardware 104 can similarly include three lips 308 spaced apart from one another in the circumferential direction. The number of lips 308 and lips 214 can be equal or different from one another. In an embodiment, the circumferential lengths of the lips 214 and 308 may be approximately equal. The gaps 310 disposed between adjacent lips 308 may be equal to or greater than the circumferential lengths of the lips 214. In such a manner, the lips 214 of the pipe 106 can be translated between adjacent lips 308 of the engine hardware 104 without contacting the lips 308. After passing the lips 108, the pipe 106 can be rotated to secure the lips 214 with the lips 308. In certain instances, the lips 214 and 308 can be approximately aligned in the circumferential direction in the locked state. That is, the lips 214 and 308 can substantially overlap one another such that a contact interface formed therebetween has a size approximately equal to the size of the lips 214 and 308. In other instances, the lips 214 and 308 can have different sizes from one another or not require complete circumferential alignment for the expansion joint 108 to be in the locked, operational state. That is, locking the expansion joint 108 may not require the lips 214 and 308 to be perfectly aligned with one another as long as there is some degree of circumferential overlap, as viewed along the axial direction, A.

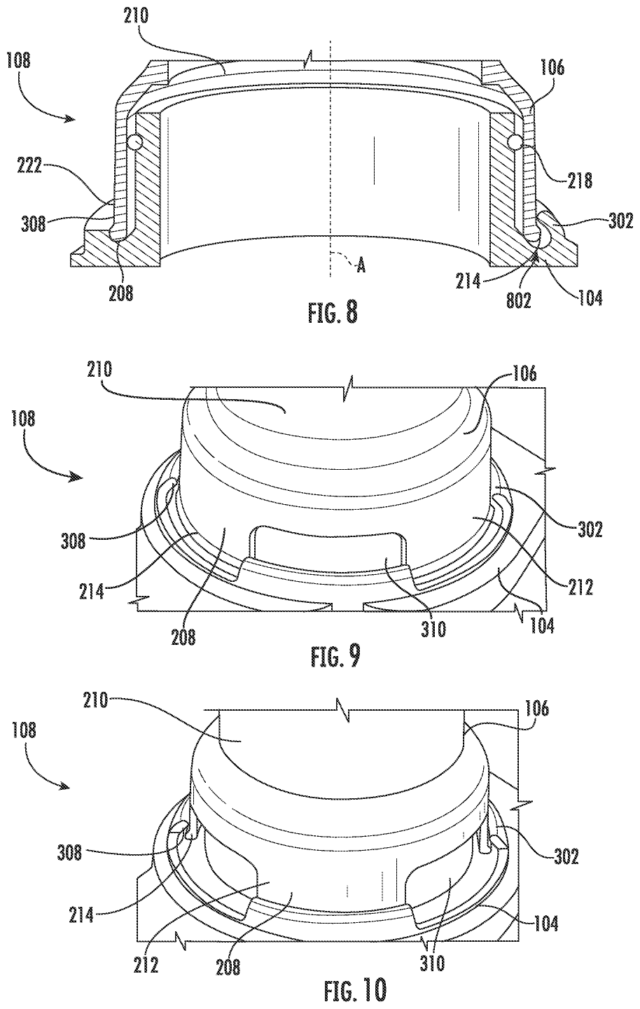

FIG. 9 illustrates the expansion joint 108 in a semi-assembled state whereby the lips 214 of the pipe 106 are in proper axial alignment with respect to the lips 308 of the engine hardware 104 but in an unlocked state, i.e., not secured therewith. FIG. 10 illustrates the expansion joint 108 in an assembled (i.e., locked) state whereby the lips 214 of the pipe 106 are in proper axial and circumferential alignment with the lips 308 of the engine hardware 104. In the state illustrated in FIG. 10, the pipe 106 and engine hardware 104 are coupled relative to one another. FIG. 8 illustrates the locked configuration as seen in cross section. D_{MAXSLIDE} is defined by a sliding distance between a base 802 of the engine hardware 104 and the lip 308 of the circumferentially-extending ridge 302 minus an axial dimension of the lips 214.

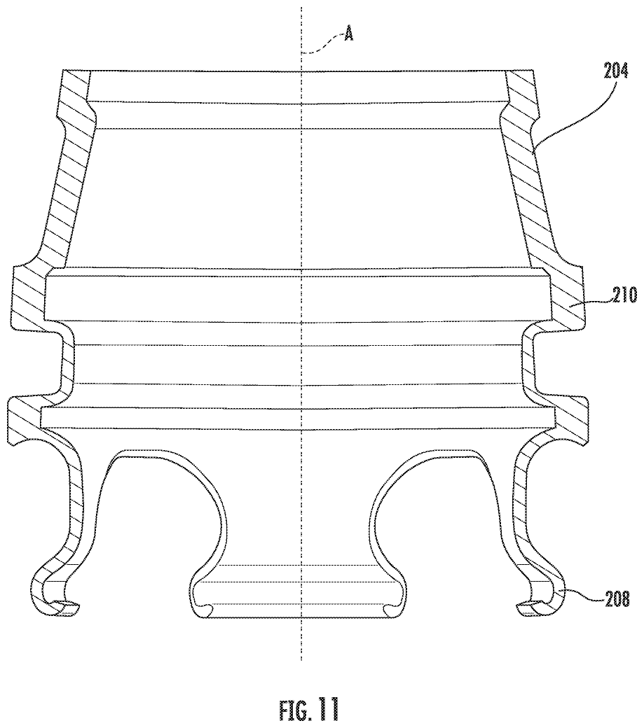

FIG. 11 illustrates a collar, such as the collar 204 previously described, created using an electroforming process. Electroforming can allow for variable wall thicknesses with minimal tolerance deviation. For instance, the hub 210 of the collar 204 can have a thicker sidewall as compared to the sidewall of the spring fingers 208. By way of example, the spring fingers 208 can have a thickness, as measured perpendicular to the axial direction A, in a range between 5 mils and 100 mils, such as in a range of 10 mils and 75 mils, such as in a range of 15 mils and 50 mils. In a particular embodiment, the spring fingers 208 has a thickness of approximately 20 mils. It is believed that a thickness of approximately 20 mils may permit easier flexure of the spring fingers 208 during installation without unnecessarily decreasing decoupling force.

Other exemplary methods of creating the collar 204 include at least one of tooling, e.g., stamping, milling, tapping, rolling, stamping, pressing, machining, and/or cutting; additive manufacturing, e.g., three-dimensional printing; extrusion; welding, joining, and/or adhering; or the like.

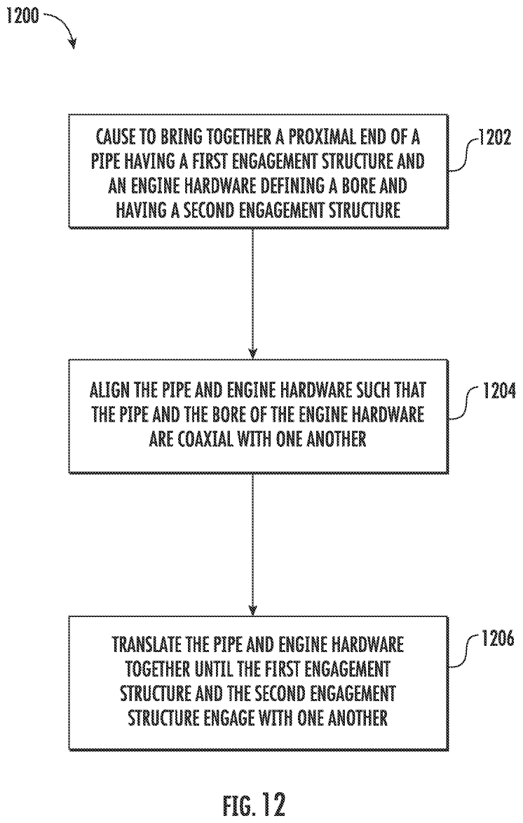

FIG. 12 illustrates an exemplary method 1200 of forming a jet engine expansion joint. The method 1200 includes a step 1202 of causing to bring together a proximal end of a pipe having a first engagement structure and an engine hardware defining a bore and having a second engagement structure. In certain instances, the step 1202 can be performed by moving only one of the pipe and engine hardware. In particular, step 1202 can be performed by moving the pipe to the engine hardware. The method 1200 can further include a step 1204 of aligning the pipe and engine hardware such that the pipe and the bore of the engine hardware are coaxial with one another. The method 1200 can also include a step 1206 of translating the pipe and engine hardware together until the first engagement structure and the second engagement structure engage with one another. In a particular embodiment, the first engagement structure can include spring fingers and the second engagement structure can include a circumferentially-extending ridge that, when combined, prevent undesirable decoupling of the pipe and engine hardware. In an embodiment, the step 1206 of translating the pipe and engine hardware together can include only translating one of the pipe and engine hardware. The step 1206 can be performed until the spring fingers pass the circumferentially-extending ridge. A tactile indication my signal to the installation operator that proper alignment is achieved. In certain instances, alignment of the pipe and engine hardware can be achieved using indicia disposed on at least one of the pipe and engine hardware. Lining up the indicia as indicated can indicate proper axial positioning of the expansion joint.

In certain embodiments, the method 1200 may further include a step of rotating at least one of the pipe and engine hardware relative to the other after the step 1206 of translating the pipe and engine hardware together. As described with respect to FIGS. 6 to 10, relative rotation between the pipe and engine hardware may lock the pipe relative to the engine hardware without requiring deflection of the pipe, or any components thereof (e.g., the spring fingers).

The operator may further test the expansion joint for expandability and/or leaks. Testing operations may include reciprocating the pipe and engage hardware relative to one another, pressurizing at least one of the pipe and engine hardware, or a combination thereof. In certain instances, the operator may test the expansion joint at multiple points during the installation operation, e.g., after coupling the first and second engagement structures together, after aligning the pipe and the engine hardware using the indicia, and at other suitable times during the installation process.

Expansion joints in accordance with one or more embodiments described herein may be configured to be easily installed while offering suitable tolerance between two or more components under load. Expansion joints described herein may be utilized without ratcheting bands, straps, and the like, thereby reducing part cost, count, and complexity. In certain instances, expansion joints described herein may be utilized in other subsystems of jet engines and in other applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

Embodiment 1. An expansion joint for a jet engine, the expansion joint comprising:
a pipe defining a proximal end having a first engagement structure, wherein the pipe is part of an air system of the jet engine; and
an engine hardware coupled with the proximal end of the pipe, the engine hardware having a second engagement structure engaged with the first engagement structure to couple the pipe and engine hardware relative to one another,
wherein one of the first and second engagement structures comprises one or more spring fingers, and wherein the other of the first and second engagement structures comprises a ridge extending along a circumferential direction of such engagement structure.

Embodiment 2. The expansion joint of any one of the embodiments, wherein the pipe comprises a conduit and a collar disposed at the proximal end of the pipe, and wherein the first engagement structure is disposed on the collar of the pipe.

Embodiment 3. The expansion joint of any one of the embodiments, further comprising alignment indicia disposed on at least one of the pipe and engine hardware, the alignment indicia configured to be used by an operator to align the pipe and engine hardware relative to one another.

Embodiment 4. The expansion joint of any one of the embodiments, wherein the ridge comprises a plurality of discontinuous segments extending along the circumferential direction spaced apart from each other by gaps, and wherein the gaps have circumferential lengths no less than a circumferential length of the one or more spring fingers.

Embodiment 5. The expansion joint of any one of the embodiments, wherein the pipe and engine hardware define a maximum relative sliding distance, D_{MAXSLIDE}, as measured by a relative sliding distance between the pipe and engine hardware in an axial direction of the expansion joint, and wherein a length of the maximum relative sliding distance, D_{MAXSLIDE}, is at least partially defined by the first and second engagement structures.

Embodiment 6. The expansion joint of any one of the embodiments, further comprising an O-ring disposed radially between the pipe and the engine hardware, wherein the O-ring is disposed between an open end of the engine hardware and the second engagement structure.

Embodiment 7. The expansion joint of any one of the embodiments, wherein a portion of the pipe and engine hardware are coaxial with one another along an axial direction of the expansion joint, and wherein the pipe is configured to translate relative to the engine hardware along the axial direction upon occurrence of one or more loading forces.

Embodiment 8. The expansion joint of any one of the embodiments, wherein the one or more spring fingers are configured to deflect in a radial direction of the expansion joint, and

wherein a stiffness of the one or more spring fingers is within a prescribed range to prevent undesirable decoupling between the pipe and engine hardware.

Embodiment 9. The expansion joint of any one of the embodiments, wherein the pipe and engine hardware are releasably coupled together at the expansion joint.

Embodiment 10. A pipe for an air system of a jet engine, the pipe being configured to be coupled with an engine hardware defining a second engagement structure and a bore for air passage, the pipe comprising:
a conduit; and
a collar disposed at a proximal end of the conduit and configured to be coupled to the engine hardware, the collar comprising:
   a first engagement structure including a plurality of spring fingers configured to be coupled with the second engagement structure of the engine hardware; and
   indicia marking an axial alignment location of the pipe relative to the engine hardware in an axial direction.

Embodiment 11. The pipe of any one of the embodiments, wherein the conduit and collar are integral with one another.

Embodiment 12. The pipe of any one of the embodiments, wherein the second engagement structure comprises a ridge extending along a circumferential direction of the collar, wherein the ridge is discontinuous and comprises a plurality of ridge sections each spaced apart by a gap, and wherein the plurality of spring fingers each define circumferential lengths less than the circumferential dimension of the gap.

Embodiment 13. The pipe of any one of the embodiments, wherein each of the plurality of spring fingers are configured to deflect in a radial direction, and wherein a stiffness of the one or more spring fingers is within a prescribed range to prevent undesirable decoupling between the pipe and engine hardware.

Embodiment 14. A method of forming a jet engine expansion joint, the method comprising:
moving a proximal end of a pipe having a first engagement structure towards an engine hardware defining a bore and having a second engagement structure;
aligning the pipe and engine hardware such that the pipe and the bore of the engine hardware are coaxial with one another; and
translating the pipe and engine hardware together until the first engagement structure and the second engagement structure engage with one another.

Embodiment 15. The method of any one of the embodiments, further comprising:
rotating at least one of the pipe and engine hardware relative to the other after the first engagement structure and the second engagement structure are engaged with one another.

Embodiment 16. The method of any one of the embodiments, wherein rotating at least one of the pipe and engine hardware relative to the other is performed until the first and second engagement structures overlap as viewed along an axial direction of the bore.

Embodiment 17. The method of any one of the embodiments, wherein translating the pipe and engine hardware together is performed such that at least one of the first engagement structure and second engagement structure elastically deforms in a radial direction normal to an axial direction of the bore.

Embodiment 18. The method of any one of the embodiments, wherein aligning the pipe and engine hardware is performed by translating the pipe and engine hardware relative to one another until an alignment indicia on at least one of the pipe and engine hardware aligns with an appropriate portion of the other one of the pipe and engine hardware.

Embodiment 19. The method of any one of the embodiments, wherein engaging the first and second engagement structure together creates a tactile indication to an installation operator.

Embodiment 20. The method of any one of the embodiments, further comprising testing the expansion joint after translating the pipe and engine hardware together, wherein testing comprises reciprocating the pipe and engine hardware relative to each other, pressurizing at least one of the pipe and engine hardware, or a combination thereof

What is claimed is:

1. An expansion joint for a jet engine, the expansion joint comprising:
a pipe defining a proximal end having a first engagement structure, wherein the pipe is part of an air system of the jet engine; and
an engine hardware coupled with the proximal end of the pipe, the engine hardware having a second engagement structure engaged with the first engagement structure to couple the pipe and engine hardware relative to one another,
wherein one of the first and second engagement structures comprises one or more spring fingers, and wherein the other of the first and second engagement structures comprises a ridge extending along a circumferential direction of such engagement structure.

2. The expansion joint of claim 1, wherein the pipe comprises a conduit and a collar disposed at the proximal end of the pipe, and wherein the first engagement structure is disposed on the collar of the pipe.

3. The expansion joint of claim 1, further comprising alignment indicia disposed on at least one of the pipe and engine hardware, the alignment indicia configured to be used by an operator to align the pipe and engine hardware relative to one another.

4. The expansion joint of claim 1, wherein the ridge comprises a plurality of discontinuous segments extending along the circumferential direction spaced apart from each other by gaps, and wherein the gaps have circumferential lengths no less than a circumferential length of the one or more spring fingers.

5. The expansion joint of claim 1, wherein the pipe and engine hardware define a maximum relative sliding distance, D_{MAXSLIDE}, as measured by a relative sliding distance between the pipe and engine hardware in an axial direction of the expansion joint, and wherein a length of the maximum relative sliding distance, D_{MAXSLIDE}, is at least partially defined by the first and second engagement structures.

6. The expansion joint of claim 1, further comprising an O-ring disposed radially between the pipe and the engine hardware, wherein the O-ring is disposed between an open end of the engine hardware and the second engagement structure.

7. The expansion joint of claim 1, wherein a portion of the pipe and engine hardware are coaxial with one another along an axial direction of the expansion joint, and wherein the pipe is configured to translate relative to the engine hardware along the axial direction upon occurrence of one or more loading forces.

8. The expansion joint of claim 1, wherein the one or more spring fingers are configured to deflect in a radial direction of the expansion joint, and wherein a stiffness of the one or more spring fingers is within a prescribed range to prevent undesirable decoupling between the pipe and engine hardware.

9. The expansion joint of claim 1, wherein the pipe and engine hardware are releasably coupled together at the expansion joint.

10. A pipe for an air system of a jet engine, the pipe being configured to be coupled with an engine hardware defining a second engagement structure and a bore for air passage, the pipe comprising:
a conduit; and
a collar disposed at a proximal end of the conduit and configured to be coupled to the engine hardware, the collar comprising:
a first engagement structure including a plurality of spring fingers configured to be coupled with the second engagement structure of the engine hardware; and
indicia marking an axial alignment location of the pipe relative to the engine hardware in an axial direction.

11. The pipe of claim 10, wherein the conduit and collar are integral with one another.

12. The pipe of claim 10, wherein the second engagement structure comprises a ridge extending along a circumferential direction of the collar, wherein the ridge is discontinuous and comprises a plurality of ridge sections each spaced apart by a gap, and wherein the plurality of spring fingers each define circumferential lengths less than the circumferential dimension of the gap.

13. The pipe of claim 10, wherein each of the plurality of spring fingers are configured to deflect in a radial direction, and wherein a stiffness of the one or more spring fingers is within a prescribed range to prevent undesirable decoupling between the pipe and engine hardware.

14. A method of forming a jet engine expansion joint, the method comprising:
moving a proximal end of a pipe having a first engagement structure towards an engine hardware defining a bore and having a second engagement structure;
aligning the pipe and engine hardware such that the pipe and the bore of the engine hardware are coaxial with one another; and
translating the pipe and engine hardware together until the first engagement structure and the second engagement structure engage with one another.

15. The method of claim 14, further comprising:
rotating at least one of the pipe and engine hardware relative to the other after the first engagement structure and the second engagement structure are engaged with one another.

16. The method of claim 15, wherein rotating at least one of the pipe and engine hardware relative to the other is performed until the first and second engagement structures overlap as viewed along an axial direction of the bore.

17. The method of claim 14, wherein translating the pipe and engine hardware together is performed such that at least one of the first engagement structure and second engagement structure elastically deforms in a radial direction normal to an axial direction of the bore.

18. The method of claim 14, wherein aligning the pipe and engine hardware is performed by translating the pipe and engine hardware relative to one another until an alignment indicia on at least one of the pipe and engine hardware aligns with an appropriate portion of the other one of the pipe and engine hardware.

19. The method of claim 14, wherein engaging the first and second engagement structure together creates a tactile indication to an installation operator.

20. The method of claim 14, further comprising testing the expansion joint after translating the pipe and engine hardware together, wherein testing comprises reciprocating the pipe and engine hardware relative to each other, pressurizing at least one of the pipe and engine hardware, or a combination thereof.
